(19) United States
(12) Patent Application Publication
(10) Pub. No.: US 2015/0119086 A1
(43) Pub. Date: Apr. 30, 2015

(54) SIMULTANEOUS LOCALIZATION AND MAPPING SYSTEMS AND METHODS

(71) Applicant: Alcatel-Lucent USA Inc., Murray Hill, NJ (US)

(72) Inventors: Piotr W. Mirowski, New York, NY (US); Tin K. Ho, Milburn, NJ (US); William M. MacDonald, Bridgewater, NJ (US)

(73) Assignee: Alcatel-Lucent USA Inc., Murray Hill, NJ (US)

(21) Appl. No.: 14/063,735

(22) Filed: Oct. 25, 2013

(51) Int. Cl. H04W 4/02; G01C 21/12; H04W 4/04

(52) U.S. Cl. CPC H04W 4/028; H04W 4/043; G01C 21/12
USPC 455/456.6

(57) ABSTRACT

A system and method for providing localization and mapping within an environment includes at least one mobile device adapted to be moved within the environment. The at least one mobile device includes an inertial measurement unit and at least one radio frequency receiver. The at least one mobile device detects inertial measurements through the inertial measurement unit and values of signal strength through the at least one radio frequency receiver. The system and method also includes a localization module that provides simultaneous localization and mapping of the at least one mobile device within the environment based at least on the inertial measurements detected by the inertial measurement unit and the values of signal strength detected by the at least one radio frequency receiver.

### FIELD OF THE INVENTION

The present invention relates to localization and mapping.

### BACKGROUND OF THE INVENTION

There is an increasing need to provide localization and mapping in environments where global positioning systems (GPS) cannot be reliably used, such as in indoor environments where GPS signals are not typically able to register. Localization and mapping of these indoor environments is desirable both for location-based services and for network deployment optimization for pervasive computing. However, known localization and mapping systems for GPS-deprived environments lack accuracy or require too resource-intensive computations and/or specialized hardware to be widely employed.

### SUMMARY

According to an embodiment, a system for providing localization and mapping within an environment includes at least one mobile device adapted to be moved within the environment, the at least one mobile device including an inertial measurement unit and at least one radio frequency receiver. The at least one mobile device detects inertial measurements through the inertial measurement unit and values of signal strength through the at least one radio frequency receiver. The system also includes a localization module receiving the inertial measurements and the values of signal strength. The localization module provides simultaneous localization and mapping of the at least one mobile device within the environment based at least on the inertial measurements detected by the inertial measurement unit and the values of signal strength detected by the at least one radio frequency receiver.

According to an embodiment, the system also includes a display for displaying an estimated trajectory of the at least one mobile device.

According to an embodiment, the at least one mobile device may include a plurality of radio frequency receivers of different modalities, and the localization module may provide localization based on values of signal strength detected by the plurality of radio frequency receiver.

According to an embodiment, the plurality of radio frequency receivers may include a WiFi receiver and a 4G LTE receiver.

According to an embodiment, the plurality of radio frequency receivers may include a Bluetooth receiver.

According to an embodiment, the inertial sensor may include a three-axis accelerometer and a three-axis gyroscope.

According to an embodiment, the system may also include at least one of a global positioning system, a near field communication chip and a camera adapted to read two-dimensional barcodes. The simultaneous localization and mapping provided by the localization module may also be based on absolute landmark positions detected by at least one of the global positioning system, near field communication chip or camera.

According to an embodiment, a computerized method includes detecting, through an inertial sensor of at least one mobile device, inertial measurements as the at least one mobile device is moved within an environment, and detecting, through a radio frequency receiver of the at least one mobile device, values of radio frequency signal strength as the mobile device is moved within the environment. The computerized method further includes estimating a trajectory of the mobile device within the environment based at least on the inertial measurements from the inertial sensor and the values of signal strength detected by the radio frequency receiver.

According to an embodiment, the computerized method also includes displaying an estimated trajectory of the at least one mobile device.

According to an embodiment, the computerized method also includes generating a signal strength map by projecting the values of signal strength detected by the radio frequency receiver on positions of the estimated trajectory.

According to an embodiment, the values of signal strength include 4G LTE reference signal received power.

According to an embodiment, the computerized method additionally includes detecting, through a plurality of radio frequency receivers of the at least one mobile device, values of radio frequency signal strength of different modalities as the mobile device is moved within the environment, and estimating the trajectory of the mobile device within the environment based on the values of signal strength of different modalities.

According to an embodiment, the computerized method additionally includes detecting, by the mobile device, at least one absolute landmark positions through at least one of a global positioning system, a near field communication chip and a camera adapted to read two-dimensional barcodes, and estimating the trajectory of the mobile device within the environment based on that at least one absolute landmark position.

According to an embodiment, the computerized method additionally includes tracking a second mobile device within the environment based on the trajectory estimate of the first mobile device.

According to an embodiment, a non-transitory, tangible computer-readable medium storing instructions adapted to be executed by at least one processor of a mobile device to perform a method may comprise the steps of detecting, through an inertial sensor of the mobile device, inertial measurements as the mobile device is moved within an environment, detecting, through a radio frequency receiver of the mobile device, values of radio frequency signal strength as the mobile device is moved within the environment, and estimating, by a localization module executing on the at least one processor, a trajectory of the mobile device within the environment based at least on the inertial measurements from the inertial sensor and the values of signal strength detected by the radio frequency receiver.

According to an embodiment, the method may also include displaying an estimated trajectory of the mobile device.

According to an embodiment, the method may also include generating a signal strength map by projecting the values of signal strength detected by the radio frequency receiver on positions of the estimated trajectory.

According to an embodiment, the values of signal strength may include 4G LTE reference signal received power.

According to an embodiment, the method may additionally include detecting, through a plurality of radio frequency receivers of the at least one mobile device, values of radio frequency signal strength of different modalities as the mobile device is moved within the environment, and estimating, by the localization module executing on the processor, the trajectory of the mobile device within the environment based on the values of signal strength of different modalities.

According to an embodiment, the method may additionally include detecting, by the mobile device, at least one absolute landmark positions through at least one of a global positioning system, a near field communication chip and a camera adapted to read two-dimensional barcodes, and estimating, by the localization module executing on the processor, the trajectory of the mobile device within the environment based on that at least one absolute landmark position.

These and other embodiments will become apparent in light of the following detailed description herein, with reference to the accompanying drawings.

### BRIEF DESCRIPTION OF THE DRAWINGS

FIG. 1 is a schematic diagram of a system according to an embodiment;

FIG. 2 is schematic diagram of an embodiment for providing simultaneous localization and mapping with the system of FIG. 1;

FIG. 3 is a flow diagram of an embodiment for providing simultaneous localization and mapping with the system of FIG. 1;

FIG. 4 is a graphical representation of trajectories from the system of FIG. 1 according to an embodiment;

FIG. 5 is a map image generated by the system of FIG. 1 according to an embodiment; and

FIG. 6 is a graphical representation of signal strengths from the system of FIG. 1 according to an embodiment.

### DETAILED DESCRIPTION

Before the various embodiments are described in further detail, it is to be understood that the invention is not limited to the particular embodiments described. It will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

Referring to FIG. 1, a system 10 for simultaneous localization and mapping is shown. The system 10 includes at least one processor 12, an inertial measurement unit (IMU) 14 operatively connected to the at least one processor 12, one or more radio frequency (RF) receivers 16 operatively connected to the at least one processor 12, and a localization module 18 adapted to be executed by the at least one processor 18. The system 10 may also include memory 20 for storing measurements taken by the IMU 14 and valued detected by the one or more RF receivers 16. The IMU 14 may include all of the inertial sensors available on a modern smart phone including a three-axis accelerometer, three-axis gyroscope and three-axis magnetometer, thereby allowing the IMU 14 to track three-dimensional orientation (yaw, pitch and roll angles) at high frequency. The one or more radio frequency receivers 16 may detect multiple modalities of RF transmissions including WiFi, 4G Long Term Evolution (LTE) and/or Bluetooth transmissions. The system 10 may also include one or more of a camera 22, global positioning system (GPS) 24 and/or near field communication (NFC) chip 26 for determining absolute position data, as will be discussed in greater detail below.

The system 10 includes the necessary electronics, software, memory, storage, databases, firmware, logic/state machines, microprocessors, communication links, and any other input/output interfaces to perform the functions described herein and/or to achieve the results described herein. For example, the system 10 may include the processor 12 and memory 20, which may include system memory, including random access memory (RAM) and read-only memory (ROM). Suitable computer program code may be provided to the system 10 for executing numerous functions, including those discussed in connection with the localization module 18.

The processor 12 may include one or more conventional microprocessors and one or more supplementary co-processors such as math co-processors or the like. The processor 12 may communicate with other networks and/or devices such as servers, other processors, computers, cellular telephones, tablets and the like.

The processor 12 may be in communication with the memory 20, which may comprise an appropriate combination of magnetic, optical and/or semiconductor memory, and may include, for example, RAM, ROM, flash drive, an optical disc such as a compact disc and/or a hard disk or drive. The processor 12 and the memory 20 each may be, for example, located entirely within a single computer or other device; or connected to each other by a communication medium, such as a USB port, serial port cable, a coaxial cable, an Ethernet type cable, a telephone line, a radio frequency transceiver or other similar wireless or wired medium or combination of the foregoing.

The memory 20 may store inertial measurements taken by the IMU 14 and/or RF signal measurements from the plurality of RF receivers 16 and may also store any other information required by the localization module 18, an operating system for the system 10, and/or one or more other programs (e.g., computer program code and/or a computer program product) adapted to direct the localization module 18 to perform according to the various embodiments discussed herein. For example, the memory 20 may also store graphical images for outputting mapped data as discussed herein. The localization module 18 and/or other programs may be stored, for example, in a compressed, an uncompiled and/or an encrypted format, and may include computer program code executable by the processor 12. The instructions of the computer program code may be read into a main memory of the processor 12 from the memory 20 or a computer-readable medium other than the memory 20. While execution of sequences of instructions in the program causes the processor 12 to perform the process steps described herein, hard-wired circuitry may be used in place of, or in combination with, software instructions for implementation of the processes of the present invention. Thus, embodiments of the present invention are not limited to any specific combination of hardware and software.

The methods and programs discussed herein may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such providing simultaneous localization and mapping. In an embodiment, an application of executable code may be a compilation of many instructions, and may even be distributed over several different code partitions or segments, among different programs, and across several devices.

The term “computer-readable medium” as used herein refers to any medium that provides or participates in providing instructions and/or data to the processor 12 of the system 10 (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 12 (or any other processor of a device described herein) for execution. For example, the instructions may initially be stored on a magnetic disk of a remote computer (not shown). The remote computer can load the instructions into its dynamic memory and send the instructions over an Ethernet connection, cable line, telephone line using a modem, wirelessly or over another suitable connection. A communications device local to a computing device can receive the data on the respective communications line and place the data on a system bus for the processor 12. The system bus carries the data to the main memory, from which the processor 12 retrieves and executes the instructions. The instructions received by main memory may optionally be stored in memory 20 either before or after execution by the processor 12. In addition, instructions may be received via a communication port as electrical, electromagnetic or optical signals, which are exemplary forms of wireless communications or data streams that carry various types of information.

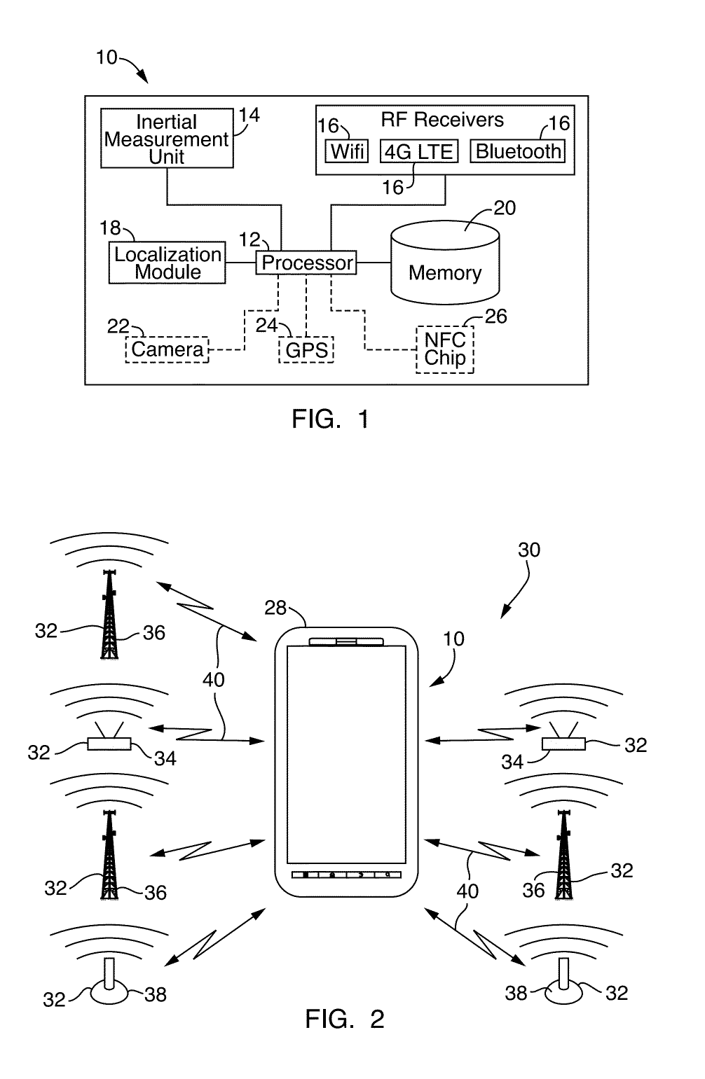

Referring to FIG. 2, in an embodiment, the system 10 may be implemented on a mobile electronic device 28 for simultaneous localization and mapping of the mobile electronic device 28 within an environment 30. The environment 30 includes a plurality of RF communication links 32 for enabling pervasive computing within the environment 30. The plurality of RF communication links 32 may include communication links of different modalities including WiFi access points 34, 4G LTE small cells 36, Bluetooth links 38 or the like. The environment 30 may be, for example, an environment where localization through global positioning systems (GPS) is denied, deprived or otherwise, at least partially, unavailable due to poor signal quality or the like. For example, the environment 30 may be an indoor environment such as an office building, shopping mall, subway station, school, airport, residential building, campus or any other similar environment. The mobile electronic device 28 may be a cellular telephone, smart phone, tablet, or any similar portable device that may be worn and/or carried by a user inside the environment 30. The mobile electronic device 28 may receive RF signals 40 from none, one or more of the RF communication links 32, depending upon a location of the mobile electronic device 28 in the environment 30.

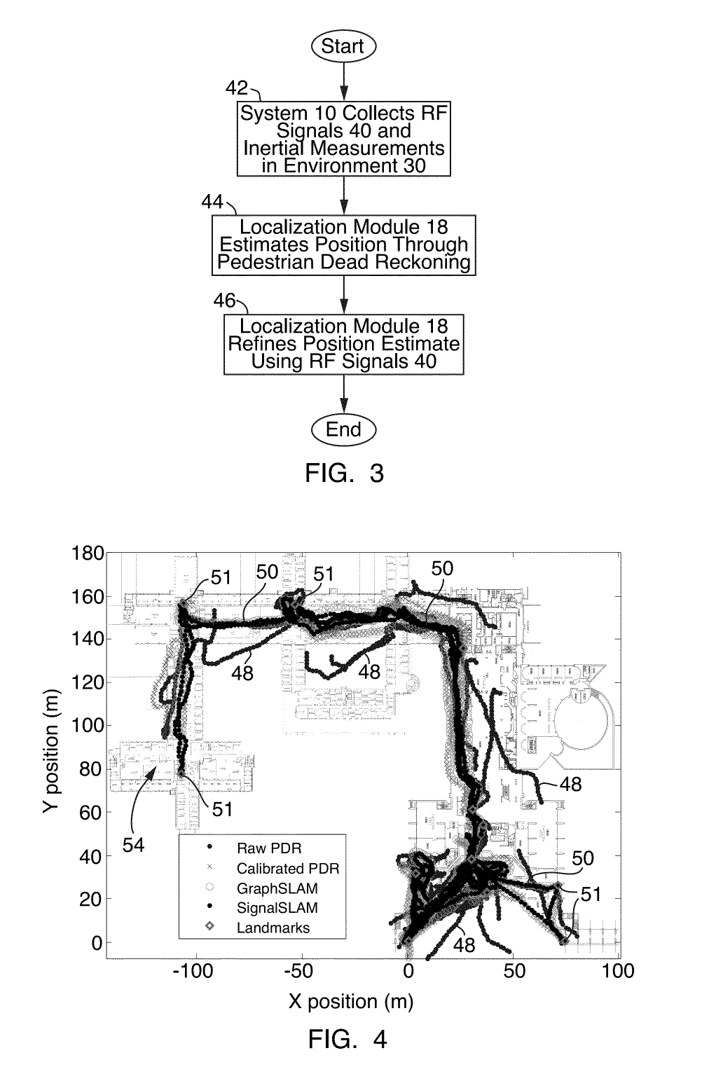

Referring to FIG. 3, in operation, as the user walks through the environment 30 with the mobile electronic device 28, shown in FIG. 2, at step 42, the system 10 collects time-stamped RF signals 40 from the plurality of RF communication links 32, shown in FIG. 2, and time-stamped inertial measurements through the IMU 14, shown in FIG. 1. For example, in an embodiment, the user may collect the time-stamped RF signals 40 and inertial measurements while walking freely through the environment 30, such as an office building, taking care of their daily activities. As the user walks through the environment 30 the mobile electronic device 28, shown in FIG. 2, may collect a variety of sensor data including time-stamped WiFi and Bluetooth Received Signal Strength, 4G LTE Reference Signal Received Power, magnetic field magnitude, GPS reference points when outdoors, Near-Field Communication (NFC) tags and/or two-dimensional bar code readings at specific landmarks. As discussed in greater detail below, the system 10 advantageously allows for data acquisition at step 42 to occur with the mobile electronic device 28 remaining in the user's pocket or otherwise put away, at least a majority of the time.

At step 44, the localization module 18 uses the inertial measurements to perform pedestrian dead reckoning to incrementally estimate a trajectory of the mobile electronic device 28, shown in FIG. 2, and, thus, the user carrying the mobile electronic device 28, shown in FIG. 2. At step 46, the localization module 18 then refines the trajectory estimate using RF signal similarities to provide the simultaneous localization and mapping of the mobile electronic device 28, shown in FIG. 2, within the environment 30.

To perform pedestrian dead reckoning at step 44, the localization module 18 first detects and counts steps taken by the user through the inertial measurements of the IMU 14, shown in FIG. 1. As discussed above, the IMU 14, shown in FIG. 1, tracks three-dimensional orientation (yaw, pitch and roll angles) at high frequency. For example, the system 10 may be implemented on a smart phone running the Android Operating System and may sample accelerometer and gyroscope measurements at 50 Hz. Step detection may be performed by detecting peaks in a vertical component of acceleration (i.e. every time that the user's foot hits the floor) as measured by the IMU 14, shown in FIG. 1. To detect the peaks, the localization module 18 may first use the three-dimensional orientation (yaw, pitch and roll angles) to rotate the raw accelerometer readings from the IMU 14, shown in FIG. 1, which are in a coordinate system of the mobile electronic device 28, shown in FIG. 2, to accelerometer readings in a local ground coordinate system defined by longitude, latitude and upright axes. The localization module 18 may then extract the vertical component of acceleration from the inertial measurements by detecting peaks in the rotated vertical component of acceleration. For example, the localization module 18 may detect peaks by median-filtering the vertical component of acceleration to remove noise and then computing a sliding-window variance on a window of the filtered acceleration, which is thresholded to reveal the peaks. The localization module 18 may, for example, detect a step or stride corresponding to two consecutive peaks of the variance of acceleration within a specified time window, such as a time window between 0.5 seconds and 1.5 seconds.

Once the localization module 18 determines that the user has taken a step, the localization module 18 estimates the position of the mobile electronic device 28 after the step relative to the position of the mobile electronic device 28 prior to the step using motion model equations:

[symbol]

(1)

[symbol]

(2)

[symbol]

(3)

where:

[symbol] is the X coordinate after the step;

[symbol] is the Y coordinate after the step;

[symbol] is a yaw after the step;

[symbol] is the X coordinate prior to the step;

[symbol] is the Y coordinate prior to the step;

[symbol] is a yaw prior to the step;

[symbol] is a pocket offset angle;

[symbol] is a yaw increment during the step;

[symbol] is an offset angle between an arbitrary map coordinate system and the local ground coordinate system; and

[symbol] is a length of the stride.

The localization module 18 estimates a heading of the user and mobile electronic device 28 as a combination of the yaw value θₜ and the pocket offset angle βₜ by using the three-dimensional orientation of the mobile electronic device 28, as measured by the IMU 14, shown in FIG. 1, at every time point. In particular, the localization module 18 first estimates the orientation of the mobile electronic device 28 relative to the longitude axis in the ground coordinate system using the yaw measurement from the IMU 14, shown in FIG. 1, which is the angle between the longitude axis in the ground coordinate system and the projection of the X-axis of the coordinate system of the mobile electronic device 28 onto the ground plane. For example, the localization module 18 may median filter the yaw measurements over a number of time points (e.g. five) and average the filtered measurements within the time interval corresponding to one stride to estimate the yaw increment during the step φₜ and, thus, the yaw value θₜ. Using the yaw value θₜ, the localization module 18 may estimates the heading by incrementing the yaw value θₜ by a pocket offset angle βₜ, which accounts for an orientation of the mobile electronic device 28 in the user's pocket in relation to the heading, i.e. the direction of movement. The heading estimate of the localization module 18 assumes that the walking motion is always forward and that the mobile electronic device 28 is immobile in the user's pocket. Thus, despite potential shifts of the mobile electronic device 28 in the user's pocket, βₜ may be fixed to a constant value within the time interval between two known positions, thereby simplifying calculations using the motion model equations (1), (2) and (3).

The offset angle ξ is the transform angle between the arbitrary map coordinate system (e.g. the map coordinate system of a building, campus or the like) and the local ground coordinate system defined by the longitude (towards East) and latitude (towards North) axes. In using the offset angle ξ, the localization module 18 ignores curvature of the earth at the scale of the environment 30 (e.g. the building), which is at most a few hundred meters, and considers the local ground coordinate system as orthogonal within that radius, thereby enabling affine transforms between the coordinate systems.

The length of the stride dₜ corresponds to the distance between two steps taken by the user and detected by the mobile electronic device 28. Although the length of the stride dₜ may be calculated at each step, in embodiments, the length of the stride dₜ may instead be held constant between two known positions, thereby simplifying calculations using the motion model equations (1), (2) and (3).

The position estimation of the localization module 18 using the motion model equations (1), (2) and (3) may experience long term drift, particularly where the pocket offset angle βₜ and the length of the stride dₜ have been set as constants between known positions.

Accordingly, during the walking trajectory, the localization module 18 may frequently reset the position of the mobile electronic device 28 in pedestrian dead reckoning using absolute position data from a collection of landmarks that either encode their own position (e.g., GPS readings, Near Field Communication (NFC) tags or two-dimensional bar codes) or whose position can be known in advance, such as Bluetooth dongles. To reset the position, the localization module 18 may simply assign the position (x_{1,t}; x_{2,t}) of the mobile electronic device 28 the known coordinates (y_{1,k}; y_{2,k}) of the k-th landmark.

The system 10, shown in FIG. 1, may use a variety of absolute landmarks that bear latitude and longitude coordinates and whose commonality is to be readable by the system 10, shown in FIG. 1, such as by a smart phone running the Android Operating System. For example, the localization module 18 may use GPS position fixes detected by the GPS 24, shown in FIG. 1, to obtain absolute position data. GPS position fixes may be available when the user is outdoors with the mobile electronic device 28, such as in environments that include both indoor and outdoor areas, at the entrance and/or exit to a building environment or the like. The localization module 18 may also use coordinates provided by self-describing visual two-dimensional bar codes (e.g. QR codes) that are encoding their own position. These codes may be read by the system 10 using the camera 22, shown in FIG. 1. Although the user would likely have to remove the mobile electronic device 28 from the user's pocket to read these two-dimensional bar codes, the mobile electronic device 28 could still remain in the pocket for a majority of the localization and mapping process. The localization module 18 may also use coordinates provided by the NFC chip 26, shown in FIG. 1, which may read programmable, self-describing NFC tags with their position similarly encoded. For example, a text string encoded in an NFC tag or two-dimensional bar code landmark may be easily parsed by the localization module 18 and may define the latitude, longitude and altitude (z=0) information along with a tag ID. NFC tags and/or two-dimensional bar codes may be substituted, or supplemented, by short-range (e.g. 2 m) Bluetooth beacons or dongles, which may provide the localization module 18 with absolute position data. These Bluetooth beacons may advantageously alleviate any need for taking the mobile electronic device 28 out of the pocket.

In an embodiment, the system 10, shown in FIG. 1, may also exploit organic activity landmarks, such as stairs or elevators, by activity classification based on accelerometer readings. The position of these organic activity landmarks may be easily matched on a map or the like.

In embodiments, the localization module 18 may calibrate the pedestrian dead reckoning trajectories, such as by using a Least Squares Error calibration or the like, because of long-term shifts of the mobile electronic device 28 within the user's pocket, changes of the user stride dₜ, and/or because the mobile electronic device 28 may be moved in and out of the pocket to read the position landmarks as discussed above. The calibration may include re-calibrating the values of βₜ and dₜ in each segment of time [symbol] between two landmarks I and J, of respective coordinates [symbol] and [symbol] .

To re-calibrate the values of βₜ and dₜ, the localization module 18 minimizes the Least Square Error [symbol] , where [symbol] is the pedestrian dead reckoning trajectory re-estimated by starting from [symbol] and iterating the pedestrian dead reckoning motion model equations (1), (2) and (3), using stride length [symbol] and offset angle [symbol] .

[symbol]

(4)

The values of d and β in equation (4) may be found by grid search with small step increments (e.g. 0.1 m and 5 deg, respectively) or the like. In other embodiments, the localization module 18 may not calibrate the pedestrian dead reckoning trajectories and may instead move directly to the refinement using RF signal similarities as discussed below.

After the localization module 18 performs pedestrian dead reckoning, the localization module 18 refines the estimate of position using RF signal similarities at step 46, shown in FIG. 3. The refinement provided by the localization module 18 is a solution to the challenge of building a map of observations without knowing the location of the (moving) observer. As discussed above, as the user walks around the environment 30 the system 10 collects RF signals from various access points, i.e. the plurality of RF communication links 32, shown in FIG. 2, distributed throughout the environment 30. The one or more radio frequency receivers 16, shown in FIG. 1, of the system 10 may detect multiple modalities of RF transmissions including WiFi, 4G LTE and Bluetooth transmissions and/or a magnitude of magnetic field as measured by a magnetometer. For example, for WiFi and Bluetooth, the system 10 may detect Received Signal Strength, while for 4G LTE, the system 10 may detect Received Signal Strength and/or Reference Signal Received Power. The localization module 18 calculates a measure of signal similarity under the assumption that the RF signal does not change significantly over a short distance of a few meters, which corresponds, at a walking speed, to about 5 seconds to 10 seconds. In an embodiment, the localization module 18 relies on kernel functions to compute the similarity, in signal space, between two segments of a trajectory.

For WiFi or Bluetooth data, where there can be hundreds of different access points scattered around the building, the localization module 18 may compute RF signal similarity using the Kullback-Leibler divergence between multinomials of access point visibility. For the 4G LTE Reference Signal Received Power or the magnitude of the magnetic field (as measured by a magnetometer (not shown) of the system 10), the localization module 18 may compute RF similarity using Euclidean distance. The KL divergence or the Euclidean distance may be input into a kernel function k(Sₜ_{ᵢ},Sₜ_{ⱼ}), where Sₜ_{ᵢ} is the multivariate signal recorded around time point tᵢ (for the specific mobile electronic device 28). The kernel function is either the Gaussian or the KL-divergence kernel and takes the following form: [symbol] where D is either the squared Euclidean distance or the symmetrized KL divergence [symbol] .

In the presence of multiple sources of RF data, such as WiFi Received Signal Strength, 4G LTE Reference Signal Received Power, Bluetooth Received Signal Strength or the magnitude of the magnetic field, the kernel matrices, K₁, K₂, K₃, etc., for each signal modality are multiplied, element by element, by the localization module 18 provided that the rows and columns in each matrix correspond to the same time intervals for the same mobile electronic device 28. Thus, the system localization module 18 may pre-compute the kernel similarity between the RF signals at each time interval during the trajectory and may easily combine multiple sources of RF signal by multiplying multiple kernel matrices.

Once the localization module 18 has computed the kernel similarity, for all the time segments of the trajectory from the pedestrian dead reckoning, the localization module 18 may use the kernel similarities to refine the trajectory. To refine the trajectories, the localization module 18, considers the trajectory of a mobile electronic device 28 as a sequence of poses [symbol] ; in the 2D case, each pose [symbol] is a 2D position [symbol] and an orientation angle [symbol] . The sequence of poses may be represented by a chain graph, where each pose is associated to a vertex and each motion edge corresponds to a known motion increment (in the case of pedestrian dead reckoning, each edge is a step with stride dₜ and yaw θₜ). The sequence [symbol] is produced by iterating the equations of the motion model (1), (2) and (3), as discussed above.

Whenever the mobile electronic device 28 returns, at time tⱼ, near a location previously traversed at time t, and, if the localization module 18 is able to recognize that similarity, then a new loop closure or constraint edge is added to the graph, linking xⱼ to xᵢ. These constraint edges may be added, for instance, if at time tⱼ, the mobile electronic device 28 is next to the same landmark as at time tᵢ (e.g. touching the same Bluetooth or NFC tag or seeing the same two-dimensional bar code). The localization module 18 defines the constraint edge as having a displacement equal to zero and an unknown change of orientation. If there is a gap in the pedestrian dead reckoning trajectory (or if data is collected from a different mobile electronic device starting from the same landmark), the localization module 18 inserts a constraint edge between the disjoint ends.

The localization module 18 also defines global landmarks in the chain graph, such as the position fixes given by GPS or readings from an NFC tag or QR code with their known landmark positions [symbol] . A global vertex can be added, for instance, at the origin of the coordinate system, and the displacement in the constraint landmark edge is equal to the landmark's coordinates [symbol] .

The localization module 18 begins refinement using positions and orientations derived from pedestrian dead reckoning, which means that the motion edge constraints are, initially, all satisfied while the loop closure constraint edges are initially violated because of the cumulative drift due to noisy pedestrian dead reckoning. The localization module 18 iteratively optimizes the sequence of poses [symbol] in the graph by minimizing the errors at all edges, including the violations of the loop closure and landmark constraint edges.

For any two vertices i and j in the pose graph that have an edge linking them, the localization module 18 defines:

[symbol] as the vector of constraints: it is the observed relative displacement (2D translation and change of orientation angle) between pose i and pose j, expressed from the viewpoint of pose i;

[symbol] as the calculated displacement given the current values of poses [symbol] and [symbol] , calculated from the viewpoint of pose i;

[symbol] as the error between the current configuration of poses i and j and the observed constraint; and

[symbol] as the 3×3 information matrix (inverse covariance matrix) of the constraint between pose i and j. This information matrix expresses the noise in the observation of the (pedestrian dead reckoning, loop closure, landmark) constraint but may generally be kept diagonal. The term [symbol] at row, column (3; 3) in the matrix expresses the inverse covariance of the orientation angle constraint.

The localization module 18 aims at minimizing a negative log likelihood F of all the observations over a set of C edges:

[symbol]

(5)

[symbol]

(6)

The localization module 18 obtains the solution to equation (6) by iterative local linearization. At each step, a new, optimal sequence of poses [symbol] is recomputed given the current edge constraints and the constraints on all edges are then re-evaluated given the new poses. The new sequence of poses after each step's update is decomposed as [symbol] .

At each iteration, the localization module 18 also uses the kernel similarities of RF signals to improve the error minimization. To consider kernel similarities, the localization module 18 first restricts the set or poses to time points [symbol] that correspond to time windows when signal strength was collected and between which signal similarity [symbol] was computed, as discussed above. At a given iteration of equation (6) and for the current configuration of poses [symbol] , the localization module 18 uses weighted kernel regression to predict the expected pose [symbol] based on the poses of its immediate neighbors [symbol] in the signal space (where [symbol] and [symbol] ). Such neighbors in the signal space are poses [symbol] whose kernel function [symbol] evaluates the highest. The localization module 18 may define a neighborhood Nₜ, in the signal space, of poses [symbol] at time t, and set a limit to the number of neighbors, such as ten neighbors. The weighted kernel regression of the localization module 18 predicts the following position for [symbol] :

[symbol]

(7)

That prediction [symbol] is used by the localization module 18 as a temporary absolute landmark for the next iteration of equations (5) and (6). This means that at the next iteration of equations (5) and (6), an additional signal edge is added from the pose [symbol] to the new pose [symbol] and the information matrix [symbol] specific to the signal edge constraints is unit diagonal with the exception of the orientation term [symbol] .

After each update of x, the signal similarity based prediction of each pose [symbol] is re-evaluated by the localization module 18 by re-computing equation (7). However, the localization module 18 does not change the signal similarity kernel [symbol] , or the neighbors Nₜ of [symbol] in signal space. As a consequence, the overhead introduced by using the kernel similarities of RF signals to refine the localization is negligible. Additionally, the localization module 18 is able to integrate any kind of signal similarity that is stationary (i.e. time independent), which includes for instance WiFi RSSI, 4G LTE, Bluetooth from fixed beacons or, under some circumstances, magnetic field.

The error [symbol] after the update is linearized as a sum of the current error [symbol] and a term linear in the pose update [symbol] . The minimization of equation (6) in terms of [symbol] can be expressed as a minimization of a quadratic function in terms of and therefore the global sequence of pose update [symbol] becomes the solution of a linear system. The localization module 18 reaches the locally optimal solution to the sequence of poses by iteratively recalculating the error functions [symbol] at each edge and solving for the pose update [symbol] , until convergence.

Although the simultaneous localization and mapping provided by the system 10 has been described in connection with a single mobile electronic device 28, shown in FIG. 2, for simplicity, it should be understood by those skilled in the art that the system 10 may track multiple mobile electronic devices 28, shown in FIG. 2, and may jointly optimize the trajectories of the multiple mobile electronic devices 28, shown in FIG. 2, to provide more robust mapping. Since the pedestrian dead reckoning trajectories of the multiple electronic devices 28, shown in FIG. 2, will be distinct from one another, the localization module 18 may combine the trajectories by establishing RF signal kernel similarities between specific points of the distinct trajectories of the different mobile electronic devices 28, shown in FIG. 2, in substantially the same manner that the localization module 18 establishes similarities for a single mobile electronic device 28, shown in FIG. 2.

Referring to FIG. 4, the optimization by the localization module 18 may be directly applied to close gaps and loops in the pedestrian dead reckoning trajectory 48 (which may be discontinuous because of the repeated position resets at absolute landmarks encountered on the trajectory) to provide an estimated trajectory 50 of the mobile electronic device 28 that is a smooth curve that goes through all landmarks 51 while obeying the noisy pedestrian dead reckoning data.

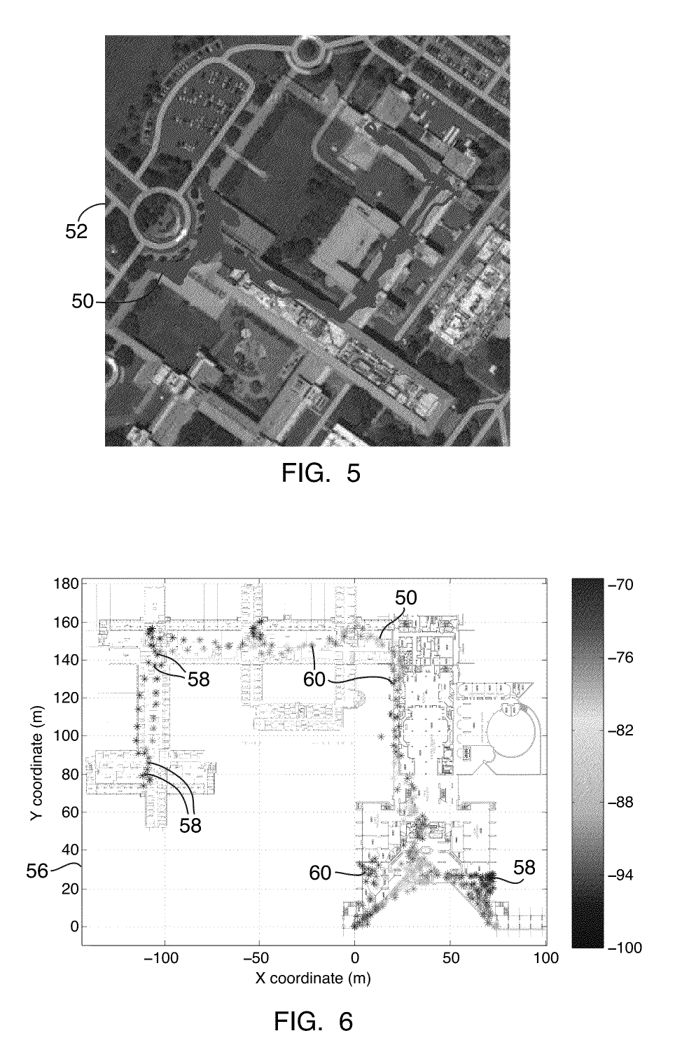

The system 10 may use the estimated trajectory 50 provided by the localization module 18 for a variety of purposes. For example, referring to FIG. 5, the system 10, shown in FIG. 1, may provide mapping of the environment 30, shown in FIG. 2, by displaying the estimated trajectory 50 on an image of the environment 30, shown in FIG. 2, which may be, for example, a satellite photograph 52, blueprint 54, shown in FIG. 4, or another similar image. Advantageously, the satellite photograph 52 may be a geo-referenced satellite image of the environment, such as a building of interest that can easily be obtained on a map search engine.

Referring to FIG. 6, the system 10, shown in FIG. 1, may also use the estimated trajectory 50 provided by the localization module 18 to generate a 4G LTE and/or WiFi signal map 56 of the environment 30, shown in FIG. 2. To generate the 4G LTE and/or WiFi signal map 56, the system 10, shown in FIG. 1, may plot the Reference Signal Received Power and/or Received Signal Strength versus the estimated trajectory 50 to provide the signal map 56 showing positions of high signal reception 58 and positions of low signal reception 60.

The 4G LTE and/or WiFi signal map 56 may advantageously be used for optimizing the deployment of telecommunication networks with the environment 30, shown in FIG. 2. For example, 4G LTE small cells have limited range (comparable to the typical WiFi access point coverage) but can be installed at multiple locations throughout the environment 30, shown in FIG. 2, (e.g. office spaces, residential areas or public spaces). Precise localization of these 4G LTE small cells is a recurring hurdle when deploying networks due to cost and quality of service considerations when planning the placement of the small cells and, thus, the system 10, shown in FIG. 1, may provide precise 4G LTE signal coverage maps 56 to aid in network deployment.

In embodiments, the 4G LTE and/or WiFi signal map 56 may also be used for geo-localization. For example, the 4G LTE and/or WiFi signal map 56 may provide a fingerprint of 4G LTE and/or WiFi RF signals from all access points or small cells within the environment 30, shown in FIG. 2. Thus, as a new mobile device is moved within the environment 30, shown in FIG. 2, a tracking module may perform a weighted kernel regression to compare RF signal received by the new mobile device to those stored in the 4G LTE and/or WiFi signal map 56. Similarities between the received RF signals may then be used to track a position of the new mobile electronic device within the environment 30, shown in FIG. 2. This geo-localization may be advantageous for institutions such as airports, shopping malls, museums and campuses that provide location, advertisement, product recommendations and/or security services.

By relying on a state-space model, where the trajectory of the user is unknown and depends both on the dynamics coming from a pedestrian motion model and on multi-sensor observations, including WiFi and/or LTE signals, the system 10, shown in FIG. 1, is advantageously able to construct the signal map from the data acquired by a freely moving pedestrian, i.e. the user, wearing the mobile electronic device 28, shown in FIG. 2, in the user's pocket, with limited or no human intervention. In particular, the system 10, shown in FIG. 1, may build the RF signal map 56 entirely from data collected by a mobile electronic device 28, shown in FIG. 2, carried in the user's pocket. This is unlike existing systems for tracking users indoors, which typically require a known RF signal map in advance.

The system 10, shown in FIG. 1, advantageously provides pose-invariant pedestrian dead reckoning that allows the user to place the mobile electronic device 28 in any pocket of a trouser or the like to simplify data collection. The system 10, shown in FIG. 1 also provide high quality refinement of the pedestrian dead reckoning data using the collection of absolute location and pairwise constraints that incorporate multi-modal signal similarity, including WiFi Received Signal Strength, Bluetooth Received Signal Strength, LTE Reference Signal Received Power or even the magnitude of the magnetic field.

The system 10, shown in FIG. 1, and method of FIG. 3 described above advantageously provide for automatic generation and updating of an RF signal map in an environment 30, shown in FIG. 2, such as a building or the like, while determining the location of the measuring device, namely, the mobile electronic device 28, such as a smart phone having typical sensors. The system 10, shown in FIG. 1, and method of FIG. 3 synthesize sensor measurements that include those from inertial measurement units as well as available RF signals to infer the unknown trajectory of the mobile electronic device 28, shown in FIG. 2.

The pedestrian dead reckoning estimates of the localization module 18, shown in FIG. 1, are advantageously robust to the pose of the mobile electronic device 28, shown in FIG. 2, thereby allowing the system 10, shown in FIG. 1, to avoid common restrictions of known simultaneous localization and mapping techniques such as requiring the users to hold the measuring device in hand. Additionally, the system 10, shown in FIG. 1, and method of FIG. 3 may advantageously accommodate multiple users and mobile electronic devices 28, shown in FIG. 2, participating in the measurements. The system 10, shown in FIG. 1, may also easily maintain WiFi/LTE signal map based geo-localization systems by crowd-souring data from multiple users over extended time periods.

Although this invention has been shown and described with respect to the detailed embodiments thereof, it will be understood by those skilled in the art that various changes in form and detail thereof may be made without departing from the spirit and the scope of the invention. For example, although the system 10, shown in FIG. 1, is described primarily in connection with providing localization in indoor environments, the system 10 may provide localization in a variety of environments, including outdoor environments or environments that include a combination of indoor and outdoor areas.

What is claimed is:

1. A system for providing localization and mapping within an environment, the system comprising:
at least one mobile device adapted to be moved within the environment, the at least one mobile device including an inertial measurement unit and at least one radio frequency receiver, the at least one mobile device detecting inertial measurements through the inertial measurement unit and values of signal strength from a plurality of sources of radio frequency signals within the environment through the at least one radio frequency receiver; and
a localization module receiving the inertial measurements and the values of signal strength, the localization module adapted to provide simultaneous localization and mapping of the at least one mobile device within the environment based at least on the inertial measurements detected by the inertial measurement unit and the values of signal strength detected by the at least one radio frequency receiver.

2. The system according to claim 1, additionally comprising a display for displaying an estimated trajectory of the at least one mobile device.

3. The system according to claim 1, wherein the at least one mobile device includes a plurality of radio frequency receivers of different modalities; and
wherein the localization module provides localization based on values of signal strength detected by the plurality of radio frequency receiver.

4. The system according to claim 3, wherein the plurality of radio frequency receivers includes a WiFi receiver and a 4G LTE receiver.

5. The system according to claim 4, wherein the plurality of radio frequency receivers includes a Bluetooth receiver.

6. The system according to claim 1, wherein the inertial sensor includes a three-axis accelerometer and a three-axis gyroscope.

7. The system according to claim 1, additionally comprising at least one of a global positioning system, a near field communication chip and a camera adapted to read two-dimensional barcodes;
wherein the simultaneous localization and mapping provided by the localization module is also based on absolute landmark positions detected by at least one of the global positioning system, near field communication chip or camera.

8. The system according to claim 1, wherein the localization module resides on the at least one mobile device.

9. A computerized method comprising the steps of:
detecting, through an inertial sensor of at least one mobile device, inertial measurements as the at least one mobile device is moved within an environment;
detecting, through a radio frequency receiver of the at least one mobile device, values of radio frequency signal strength as the mobile device is moved within the environment; and
estimating, by a localization module executing on a processor, a trajectory of the mobile device within the environment based at least on the inertial measurements from the inertial sensor and the values of signal strength detected by the radio frequency receiver.

10. The computerized method according to claim 9, additionally comprising the step of displaying an estimated trajectory of the at least one mobile device.

11. The computerized method according to claim 9, additionally comprising the step of generating a signal strength map by projecting the values of signal strength detected by the radio frequency receiver on positions of the estimated trajectory.

12. The computerized method according to claim 11, wherein the values of signal strength include 4G LTE reference signal received power.

13. The computerized method according to claim 9, comprising detecting, through a plurality of radio frequency receivers of the at least one mobile device, values of radio frequency signal strength of different modalities as the mobile device is moved within the environment; and
estimating, by the localization module executing on the processor, the trajectory of the mobile device within the environment based on the values of signal strength of different modalities.

14. The computerized method according to claim 9, additionally comprising detecting, by the mobile device, at least one absolute landmark positions through at least one of a global positioning system, a near field communication chip and a camera adapted to read two-dimensional barcodes; and
estimating, by the localization module executing on the processor, the trajectory of the mobile device within the environment based on that at least one absolute landmark position.

15. The computerized method according to claim 9, additionally comprising the step of tracking a second mobile device within the environment based on the trajectory estimate of the first mobile device.

16. The computerized method according to claim 9, wherein the localization module resides on the at least one mobile device; and
wherein the at least one mobile electronic device is positioned in a pocket of an article of clothing for an entirety of the computerized method without needing to be held in a fixed position or orientation.

17. A non-transitory, tangible computer-readable medium storing instructions adapted to be executed by at least one processor of a mobile device to perform a method comprising the steps of:
detecting, through an inertial sensor of the mobile device, inertial measurements as the mobile device is moved within an environment;
detecting, through a radio frequency receiver of the mobile device, values of radio frequency signal strength as the mobile device is moved within the environment; and
estimating, by a localization module executing on the at least one processor, a trajectory of the mobile device within the environment based at least on the inertial measurements from the inertial sensor and the values of signal strength detected by the radio frequency receiver.

18. The non-transitory, tangible computer-readable medium of claim 17, additionally storing instructions adapted to be executed by the at least one processor to perform the step of:
displaying an estimated trajectory of the mobile device.

19. The non-transitory, tangible computer-readable medium of claim 17, additionally storing instructions adapted to be executed by the at least one processor to perform the step of:
generating a signal strength map by projecting the values of signal strength detected by the radio frequency receiver on positions of the estimated trajectory.

20. The non-transitory, tangible computer-readable medium of claim 19, wherein the values of signal strength include 4G LTE reference signal received power.

21. The non-transitory, tangible computer-readable medium of claim 17, additionally storing instructions adapted to be executed by the at least one processor to perform the steps of:
detecting, through a plurality of radio frequency receivers of the at least one mobile device, values of radio frequency signal strength of different modalities as the mobile device is moved within the environment; and
estimating, by the localization module executing on the processor, the trajectory of the mobile device within the environment based on the values of signal strength of different modalities.

22. The non-transitory, tangible computer-readable medium of claim 17, additionally storing instructions adapted to be executed by the at least one processor to perform the steps of:
detecting, by the mobile device, at least one absolute landmark positions through at least one of a global positioning system, a near field communication chip and a camera adapted to read two-dimensional barcodes; and
estimating, by the localization module executing on the processor, the trajectory of the mobile device within the environment based on that at least one absolute landmark position.
